(19) United States
(12) Patent Application Publication
(10) Pub. No.: US 2017/0183041 A1
(43) Pub. Date: Jun. 29, 2017

(54) METHOD OF MAKING A SHAPED PART FOR A MOTOR VEHICLE

(71) Applicant: GEDIA Gebrueder Dingerkus GmbH, Attendorn (DE)

(72) Inventors: Thomas KINKELBUR, Dortmund (DE); Markus FOIDL, Finnentrop (DE); Nadine SCHOENEWALD, Attendorn (DE); Josef STRAUTZ, Attendorn (DE)

(21) Appl. No.: 15/461,536

(22) Filed: Mar. 17, 2017

Related U.S. Application Data
(62) Division of application No. 14/533,757, filed on Nov. 5, 2014.

(30) Foreign Application Priority Data
Nov. 11, 2013 (DE) 102013112358.9

(51) Int. Cl. B62D 27/02; B62D 29/00

(52) U.S. Cl. CPC B62D 27/023; B62D 29/007; B60Y 2410/124

(57) ABSTRACT

First and second metallic parts are joined by first providing a face of the first part with a formation projecting from and forming only a limited portion of the face and then connecting the first part with the second part by fixing the formation to a face of the second part such that the formation holds the first and second parts in a preassambled position with the faces of the first and second parts confronting and out of contact with each other at a predetermined spacing. Then the two spaced and confronting faces of the first and second parts are coated, after which the first and second parts are pushed together with deformation of the formation of the first part into a final-assembly position with the coated faces pressing directly against each other. Then the first and second parts are permanently joined together.

### CROSS REFERENCE TO RELATED APPLICATION

This application is a division of copending patent application Ser. No. 14/533,757 filed 05 Nov. 2014 with a claim to the priority of German patent application 10 2013 112 358.9 filed 11 Nov. 2013.

### FIELD OF THE INVENTION

The invention relates to a method of making a shaped part of metal, in particular steel, for a motor vehicle, having a throughgoing hole for a fastener and a perforated reinforcement plate of metal, in particular steel, that covers the hole and is fastened to the shaped part.

### BACKGROUND OF THE INVENTION

It is well-known in the prior art to reinforce shaped parts composed of metal, in particular steel, by plates or sheet metal, in particular steel, in areas where they are attached to other shaped parts or body components. Reinforcement is required at the joining points between the shaped part and other shaped parts or body components since the parts have holes at these joining points to allow them to be bolted or riveted together, with the result that these joining points form a weak point due to these holes. The weak point can be reinforced by attaching metal sheets or plates. These reinforcement metal sheets or plates are circumferentially attached at the outer edges to the shaped part, for example, soldered on or welded on.

In order to provide lasting corrosion protection, the shaped parts have a corrosion-protective coating applied to them after the metal sheet or plates for reinforcement have been securely attached to the shaped part. Applying the corrosion-protective coating is typically effected using CDC or cathodic dip coating.

The key disadvantage observed with the described measures taken to reinforce the shaped parts is that the corrosion protection cannot get between the shaped part and the reinforcement metal sheet or plate when the shaped parts are coated together with the reinforcement metal sheet or plate. As a result, the surfaces between the shaped part and the metal sheet or plate remain free of corrosion protection. Moisture can penetrate over time through extremely small cracks in this area, thereby resulting in corrosion on the contacting surfaces of the parts.

### OBJECT OF THE INVENTION

Based on this prior art, the object of the invention is therefore to provide a method of making a shaped part including a reinforcement metal sheet with improved corrosion protection.

### SUMMARY OF THE INVENTION

This object is attained by a method of joining two metallic parts comprising the steps of:
providing a first part having a face with a formation projecting from and forming only a limited portion of the face of the first part;
connecting the first part with a second part by fixing the formation to a face of the second part such that the formation holds the first and second parts in a preassambled position with the faces of the first and second parts confronting and out of contact with each other at a predetermined spacing;
coating at least the two spaced and confronting faces of the first and second parts;
pushing the first and second parts together with deformation of the formation of the first part into a final-assembly position with the coated faces pressing directly against each other; and
permanently joining the first and second parts together in the final-assembly position.

In other words, the invention proposes an approach whereby the reinforcement plate is mounted at a spacing from the shaped part, and is attached only in at least one limited portion to the shaped part.

This has the advantage that a corrosion-protection agent applied to the shaped part and the reinforcement metal sheet securely attached thereto can also penetrate into the gap between the shaped part and the reinforcement plate, thereby allowing the surfaces of the shaped part that abut each other in the specified assembly position to have the corrosion protection applied to them to prevent any corrosive spots to be created. The parts in the specified assembly position are pulled together against each other by a bolt passing through the hole.

Attachment of at least one limited portion of the reinforcement plate to the shaped part enables the reinforcement plate to be fixed on the shaped part in the spaced assembly position. Another advantageous aspect is that the approach results in substantially lower cost in terms of attaching the reinforcement plate to the shaped part since the reinforcement sheet no longer has to be soldered or welded all around its outer edge, but only at the limited portion.

When final assembly is effected, another shaped part or body component, for example is bolted onto the shaped part or body component such that the individual parts are pulled together against each other by the screwing action and the reinforcement plate bears tightly against the shaped part. These measures also prevent the contact surfaces between the shaped part and the reinforcement plate from being corroded by liquid entering through extremely small gaps.

While the shaped part is being bolted onto another shaped part or body component, angular forces act on the individual components through the fastener, for example the bolt. The fact that at least one limited portion of the reinforcement plate is attached to the shaped part means that this plate cannot rotate in the same direction simultaneously with the fastener, but remains in the intended position.

Provision is preferably made whereby the reinforcement plate has at least one tab forming the limited portion, which tab is at the outer edge of the reinforcement plate, is angled toward the shaped part, and is attached to the shaped part.

The tab that is angled toward and attached to the part secures the reinforcement plate on the shaped part with a certain clearance from the shaped part, with the result that a spacing is provided between the shaped part and the reinforcement plate when in the specified assembly position, into which gap corrosion-protection agent penetrates. Other shaped parts or body components can be attached to the shaped part during final assembly by a screwing action such that the other shaped part or body component presses the reinforcement plate against the shaped part. The tab does not present any significant resistance here and easily deforms, with the result that as the tab deforms the reinforcement plate creates a flat contact surface between the shaped part and another shaped part or body component, and enables all of the components to be optimally secured to each other.

Each reinforcement plate has at least one tab in the form of a limited portion on two opposing outer edges, which tab is angled toward the shaped part.

This ensures reliable retention of the reinforcement plate on the shaped part. Angular forces act through the fastener on the individual components, in particular, during final assembly when additional shaped parts or body components are bolted onto the shaped part. The fact that the reinforcement plate is attached by tabs at two opposite outer edges means that the plate cannot rotate simultaneously in the same direction as the fastener and is retained securely on the shaped part.

Provision is furthermore preferably made whereby the reinforcement plate and the shaped part are attached in the at least one limited portion to each other by joining means, where provision is especially preferably made whereby the reinforcement plate and the shaped part are soldered, welded, or adhesively bonded together in the at least one limited portion.

The shaped part and the reinforcement plate are attached to each other by a joining method, whereby they are preferably soldered or welded in order to ensure a secure attachment that is both inexpensive and strong. However, other joining methods can be used to unite the parts.

### BRIEF DESCRIPTION OF THE DRAWING

An embodiment of a shaped part according to the invention for a motor vehicle is shown in the drawing and described below. Therein:

FIG. 1 is a top view of a shaped part including a reinforcement plate;

FIG. 2 is an isometric view of the shaped part including reinforcement plate;

FIG. 3 is an end view of same, partly in section.

### SPECIFIC DESCRIPTION OF THE INVENTION

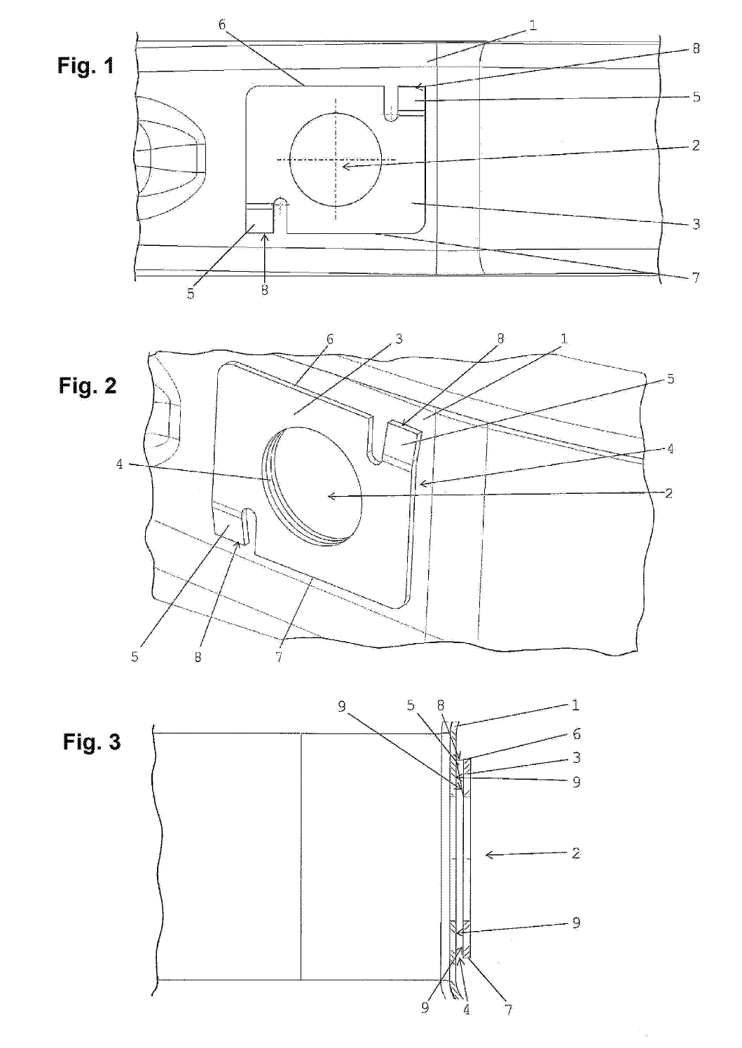

FIG. 1 shows a shaped part 1 for a motor vehicle, comprising a throughgoing hole 2 for a fastening element and a perforated reinforcement plate 3 covering the hole 2 and fixed to the shaped part 1. The reinforcement plate 3 in this embodiment is basically rectangular, although it is possible to use a reinforcement plate 3 with another shape. The shaped part 1 can be a body or a frame component. All parts are composed of metal, preferably steel.

Other shaped parts or body components can be attached to the shaped part 1 but are not shown in the drawing, the hole 2 being provided to allow insertion of a fastener appropriate for effecting secure attachment, in particular, a bolt.

The reinforcement plate 3 has two limited portions for secure attachment of the plate to the shaped part 1, these being in the form of tabs 5 that, as highlighted in FIGS. 2 and 3, are angled toward the shaped part 1 and that securely attach the reinforcement plate 3 to the shaped part 1 in a specified assembly position with a spacing 4 between the shaped part 1 and the reinforcement plate 3. The tabs 5 are on two opposing outer edges 6 and 7 of the reinforcement plate 3, ends 8 of the tabs 5 being attached to the shaped part 1, for example, welded or soldered. This is advantageous since angular forces during the screwing action act through the fastener on the individual components, and any improper rotation by the reinforcement plate 3 in the rotation direction of the fastener is precluded due to the secure attachment of the reinforcement plate 3 by the diagonally opposite tabs 5.

Attachment between the shaped part 1 and the reinforcement plate 3 is effected at the end edges 8 of the tabs 5 by welding or soldering. Other joining technologies are also possible, however.

FIG. 3, in particular, illustrates that the reinforcement plate 3 is offset by the spacing 4 from the shaped part 1. The reinforcement plate 3 is held at the spacing 4 from the shaped part 1 by the tabs 5 that are angled toward the shaped part 1. When a coating of corrosion-protection agent is applied, the corrosion-protection agent also gets into the spacing 4 between the shaped part 1 and the reinforcement plate 3, with the result that confronting faces 9 of both parts, which are pressed against each other in the specified assembly position, are also coated with a corrosion-protection agent.

The invention is not restricted to the illustrated embodiment but can be varied in multiple ways within the scope of the invention.

All novel individual features and combined features that are disclosed in the description and/or drawing are considered to be essential to the invention.

We claim:

1. A method of joining two metallic parts, the method comprising the steps of:
providing a first part having a face with a formation projecting from and forming only a limited portion of the face of the first part;
connecting the first part with a second part by fixing the formation to a face of the second part such that the formation holds the first and second parts in a preassambled position with the faces of the first and second parts confronting and out of contact with each other at a predetermined spacing;
coating at least the two spaced and confronting faces of the first and second parts;
pushing the first and second parts together with deformation of the formation of the first part into a final-assembly position with the coated faces pressing directly against each other; and
permanently joining the first and second parts together in the final-assembly position.

2. The method defined in claim 1, wherein one of the parts has a throughgoing hole for a fastener and the other part is a perforated reinforcement plate of metal that covers the hole and is fastened to the shaped part.

3. The method defined in claim 1, wherein the first and second parts are pushed and joined together and bolting through the hole.

4. The method defined in claim 2, wherein the reinforcement plate is the first plate and is formed with at least one tab constituting the formation, at an outer edge of the reinforcement plate, and angled toward the other part.

5. The method defined in claim 4, wherein the reinforcement plate has a respective such tab on each of two opposite outer edges.

6. The method defined in claim 1, further comprising the step, prior to pushing together the first and second parts, of:
welding the tab of the first part to the second part for fixing the preassembled position.
